(19) United States
(12) Patent Application Publication
(10) Pub. No.: US 2026/0151295 A1
(43) Pub. Date: Jun. 4, 2026

(54) VIBRATING NASAL DEVICE

(71) Applicant: NOSI HEALTH LTD, London (GB)

(72) Inventors: Richard BEHARRY, London (GB); Kunal VASA, London (GB)

(21) Appl. No.: 19/137,917

(22) PCT Filed: Dec. 12, 2023
(86) PCT No.: PCT/EP2023/085319

§ 371 Date: Jun. 11, 2025

(30) Foreign Application Priority Data
Dec. 12, 2022 (GB) 2218635.7

(51) Int. Cl. A61H 23/02

(52) U.S. Cl. CPC A61H 23/02; A61H 2205/023

(57) ABSTRACT

A vibrating nasal device includes two hinged members collectively housing a complete vibration mechanism adapted to provide a vibration of sufficient magnitude to provide congestive relief for a user. The hinged members collectively form a curved profile at one end adjacent the hinge to receive the bridge of a nose, tapered from a wider section adjacent the hinge to a narrow section away from the hinge and inflections to complement the transition from the side of a nose to an adjacent infra-orbital region of a user's face. The vibration mechanism includes a motor rechargeable battery, a wireless or wired charge port, a control unit, a control actuator(s) and a control light(s). The vibration mechanism includes a flexible circuit board extending between both hinged members.

### FIELD OF THE INVENTION

The present invention relates to a vibrating nasal device and, more particularly, to a vibrating nasal device that provides congestive relief through the use of vibration.

### BACKGROUND OF THE INVENTION

Nasal congestion is a common problem amongst all humans. A blocked and congested nose can cause difficulty breathing through your nose. In turn this can cause pain, tenderness, and a general feeling of discomfort. The causes of nasal congestion are broad and can range but not exclusively from sinus infections (sinusitis) and colds to common allergies and persistent rhinitis. A blocked nose is usually the result of inflamed blood vessels. Upper respiratory tract infections are infections of the part of the body involved in breathing such as the common cold, rhinitis and sinusitis. These disorders are associated with inflammation of the nasal mucosa causing poor sinus ventilation and discomfort.

There are currently known treatments such as pharmacological relief products-nasal sprays and ingested medication, that for instance, narrow blood vessels to improve drainage and clear nasal blockages. However, presently these said treatments are an invasive type of treatment with unwelcoming side effects. These side effects include but are not limited to a burning sensation, dryness in the nose, nausea, irregular heartbeat, increased blood pressure and dependence. These drugs also tend to lose their effectiveness over time. Consequently, there is a need for a non-pharmacological, non-invasive, accessible, long term relief treatment for nasal congestion, which can often be painful and inconvenient to use.

PCT patent application, publication number WO202230875A1 discloses a therapeutic device, shown in FIG. 7A, including a housing having an inlet for air to enter and an acoustic vibrator within the housing that is operable to provide an acoustic vibration to the user. A seal/mask is connected to the housing to be applied around the nose of the user. Paragraph [0005] discloses that the therapeutic device may include a vibration generator configured to provide a vibration to nasal pillows which may be attached to the seal/mask. Nasal pillows are, in accordance with paragraphs [0038] to [0040], members that fit within the user's nostrils and which can include passageways through which medication, pressurized gas, etc. may be administered.

US patent application, publication number WO2006/129305A2 discloses devices, shown in FIGS. 7B and 7C, for treating nasal congestion and/or relieving sinusitis symptoms comprising means for generating vibrations and attaching means configured to attach said generating means to a location adjacent to the patient's nasal cavity, nasal passageway or sinuses. An applicator is disclosed (feature 150 in FIG. 7C) which is unitary in nature and applies vibration to the bridge of the nose and, more specifically as detailed at paragraph, to the nasal bone. Page 10 of WO2006/129305A2 discloses that the ‘attaching means (100) to the patient's face is preferably provided by physical means, such as clippers, fasteners, vacuum means or a combination thereof’.

Chinese utility model, publication number CN213218999U discloses a C-shaped elastically deformable massage instrument, shown in FIG. 7F, with a curved main body (1) which has a nose clip mechanism (3, 4, 5, 6, 7, 8) having respective rods (4, 7) connected to infrared emitting sheets/plates (5, 8). Vibration is applied to the heated sheets/plates via the respective vibration roads. From section A-A, it appears the length of the sheets/plates relative to the height in section A-A of the C shaped body is approximately 1:7. This together with the emission of infrared from the sheets/plates (5, 8) suggest that the nose clip mechanism is sized to clip inside the nostrils, i.e. to the septum. Also, paragraph [0034] confirms the supports (11, 12) and soft bodies (9,10) contact the sides of the user's nose.

Chinese utility model, publication number CN205459758U disclose a nose massage device, shown in FIG. 7G, having an arched housing with a concaved low portion to receive a removeable arched cushion and the bridge of a user's nose. The housing houses a vibration motor, a battery and a button respectively disposed on a main board. Paragraph [0015] discloses the arched cushion can be shaped to fit a particular nose and paragraph [0027] discloses that the arched cushion can be patterned to improve friction/grip on a nose.

US patent application, publication number US2008/0195001A1 discloses a handheld apparatus for relieving sinus discomfort with ridges for gripping, shown in FIG. 7D, a motor for developing vibrational energy and an applicator for applying the vibrational energy to a user's face.

US patent application, publication number US20060000472A1 discloses a nasal device, shown in FIG. 7E, comprising a flexible strip of material adapted to be adhesively secured to nasal surfaces of a user, and a signal unit which can transmit signals to and receive signals from the user while disposed upon the nasal surfaces. For example, as disclosed in paragraph [0028], the signal unit may comprise a piezoelectric sensor for sensing vibrations of nasal issue. Similarly, a piezoelectric sensor may vibrate to communicate to the user (including audibly).

PCT patent application, publication number WO2010113046A1 and Chinese utility model, publication number CN213347482U disclose devices with stimulating members for insertion in in nasal cavities.

PCT patent application, publication number WO2020/137689A1 discloses a nasal congestion reliever which is mounted to the nose in order to relieve nasal congestion and contains 2 reservoirs for storing chemicals for an exothermic reaction.

An objection of the present invention is to provide an alternative/improved vibrating nasal device.

### SUMMARY OF THE PRESENT INVENTION

The present invention provides for a vibrating nasal device as claimed in the accompanying claims.

A device according to the present invention can provide the congestive relief described above in respect of prior art devices, but also in a manner where the device clips to the nose in a wholly self-contained fashion, can be used hands-free and/or is configured to target haptic vibration on the part of the nose where the upper lateral cartilage meets the nasal bone.

More specifically, in accordance with a first aspect of the present invention, there is provided a vibrating nasal device comprising two hinged members collectively housing a complete vibration mechanism. A basic vibration mechanism might comprise a motor(s) or piezoelectric element(s), a battery and a control element. A more complex vibration mechanism might further comprise at least one of a rechargeable battery, a wireless or wired charge port, a control unit, a control actuator(s) and a control light(s).

In accordance with a second aspect of the present invention, there is provided a vibrating nasal device comprising an elongate body housing a complete vibration mechanism and having a curved profile to receive the bridge of a user's nose and respective inflected profiles to complement the transition from the sides of a user's nose to respective adjacent infra-orbital region of a user's face.

In accordance with a third aspect of the present invention, there is provided a vibrating nasal device comprising an elongate body housing a complete vibration mechanism and having a curved profile to receive the bridge of a user's nose and respective contact areas for contacting infra-orbital regions of a user's face.

In accordance with a fourth aspect of the present invention, there is provided a vibrating nasal device comprising an elongate body housing a complete vibration mechanism adapted to provide a vibration of sufficient magnitude to provide congestive relief for a user, wherein the elongate body having a curved profile to receive the bridge of a user's nose, and wherein components of the vibration mechanism are housed by the elongate body both sides of the curved profile.

### BRIEF DESCRIPTION OF DRAWINGS

The present invention will now be described, by way of example only, with reference to the following figures in which:

FIGS. 1A to 1F are figures illustrating a vibrating nasal device according to the present invention;

FIG. 2 is a schematic of the internal components of the vibrating nasal device of FIGS. 1A to 1F;

FIG. 3A is a figure illustrating the physical layout of the components of the vibrating nasal device of FIGS. 1A to 1F;

FIG. 3B is a figure illustrating an alternative physical layout of the components of a vibrating nasal device;

FIGS. 4A to 1F are figures illustrating a further vibrating nasal device according to the present invention;

FIG. 5 is a figure illustrating a charging box for a vibrating nasal device according to the present invention;

FIG. 6 is a figure illustrating the nasal bone and connected cartilage of the nose; and

FIGS. 7A to 7G are figures showing prior art nasal devices as described above.

### DETAILED DESCRIPTION

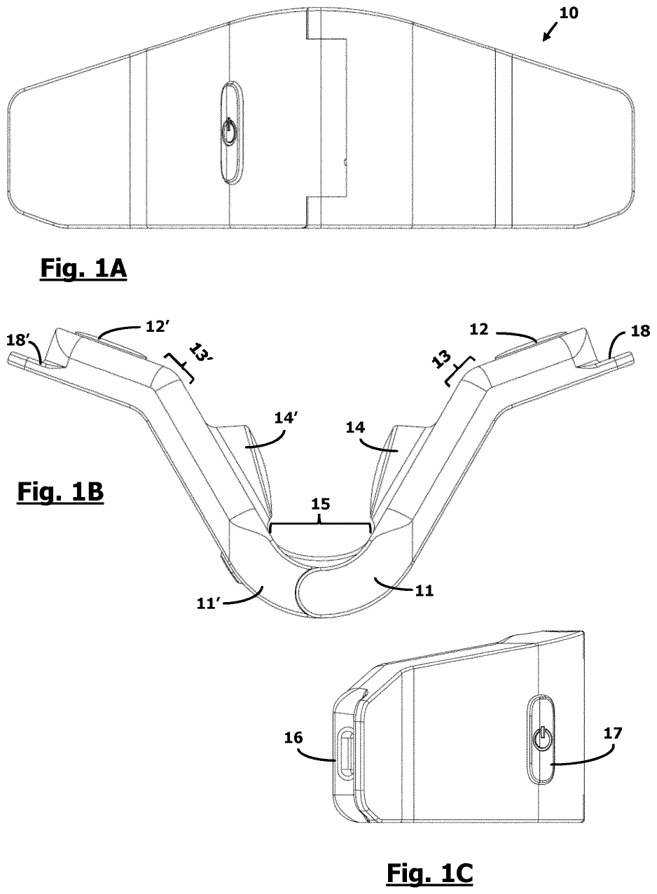

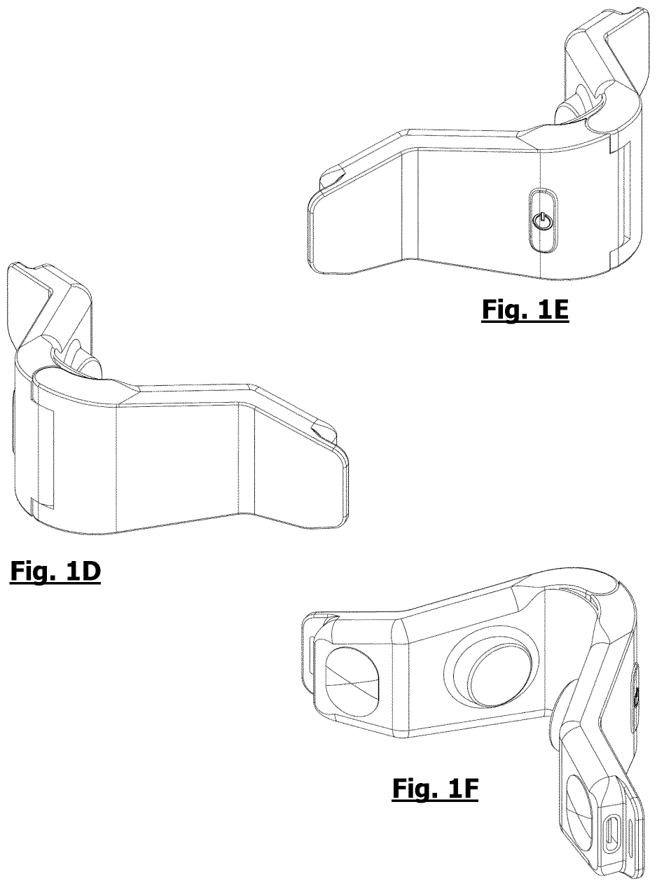

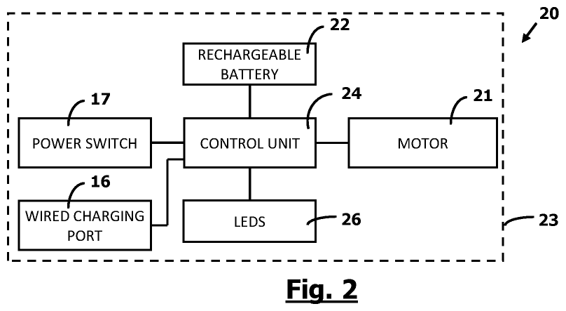

Referring to FIGS. 1A to 1F, a vibrating nasal device 10 is shown having left 11 and right 11′ hinged members (relative to the side of the face of a user with the device fitting over the bridge of the user's nose) which collectively house a complete vibration mechanism 20 (shown schematically in FIG. 2 and discussed in more detail below). The vibration mechanism 20 is adapted to provide a vibration of sufficient magnitude to provide congestive relief for a user when worn on the nose.

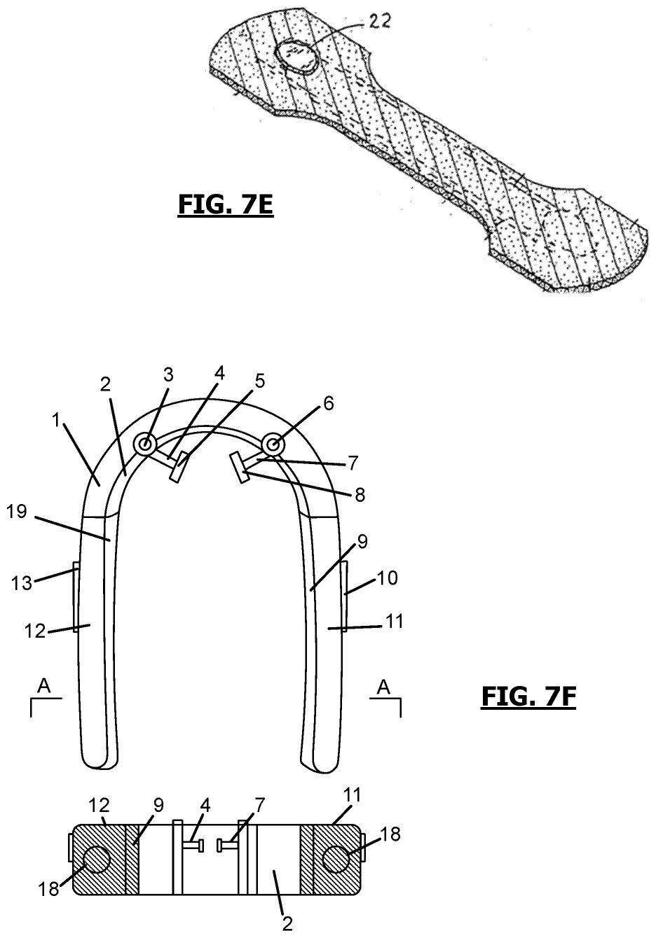

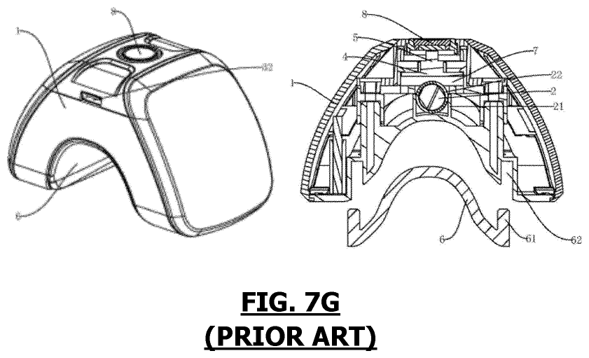

As best illustrated in FIG. 1B, the hinged members are both curved at one end to form a curved profile (15 in FIG. 1B) to receive the bridge of a nose. Alternatively, the hinge could be located elsewhere with only one hinged member having a curved profile at one end adjacent the hinge to receive the bridge of a nose. Both hinged members 11, 11′ have contact areas, specifically raised contact pads 14, 14′, for contacting and transmitting vibration to a respective side of a user's nose and, specifically, to an interface between a respective side of a user's nasal bone and connected upper lateral cartilage as illustrated in FIG. 5. In an alternative embodiment, the contact pads could be flexibly mounted with rotational degree(s) of freedom. In particular, a joint providing rotational freedom in two planes perpendicular to the contact pads (such as a ball joint) would ensure optimal contact between the contact pads and the wearer's nose. It is noted that the vibrating rods of the prior art illustrated in FIG. 7F are ‘fixedly arranged’ to the corresponding vibration devices which suggests an alternative characterisation of a device being one comprising an elongate body housing a complete vibration mechanism, the elongate body having a curved profile to receive the bridge of a user's nose and flexibly mounted contact pads (not shown) which provide one, two or three degrees of rotational freedom (in particular, in the two planes perpendicular to the contact pads with a joint such as a ball joint). As best illustrated in FIG. 1A, both hinged members are tapered from a wider section adjacent the hinge to a narrow section away from the hinge. Also, as best illustrated in FIG. 1B, both hinged members 11, 11′ are elongate with an inflected profile (13, 13′ in FIG. 1C) to complement the transition from the side of a nose to an adjacent infra-orbital region of a user's face with contact areas being provided for contacting the infra-orbital region of a user's face. Inflection is about the same axis as the curved profile which receives the bridge. Contact with the infra-orbital region locates the devices so that contact with the nose is limited to the contact pads 14, 14′ and not, for example, with the curved profile (15 in FIG. 1B) contacting the bridge of the user's nose. In principle, the contact pads 14, 14′ for contacting infra-orbital region and the inflected profiles could be employed with a unitary, non-hinged device. Indeed, an alternative characterisation of the device would be one comprising an elongate body housing a complete vibration mechanism and having a curved profile to receive the bridge of a user's nose and respective inflected profiles to complement the transition from the sides of a user's nose to respective adjacent infra-orbital region of a user's face. Moreover, a further alternative characterisation of the device, not dependent on the hinge or the inflected profile and based on the contact areas, would be one comprising an elongate body housing a complete vibration mechanism and having a curved profile to receive the bridge of a user's nose and respective contact areas for contacting infra-orbital regions of a user's face. They may also be made from silicone or rubber for comfort. Also, the hinged members 11, 11′ have respective detents 18, 18′ which enables a user to grip behind the hinged members to unclip the device from the user's nose when the device is worn.

As best illustrated in FIG. 1C, hinged member 11′ has a wired charge port 16 located at the end of a hinged member and an on/off power switch 17 on the forward-facing side of the device when worn so that both are accessible when the device is worn. LEDs 26 are incorporated to give visual feedback when the motor starts/finishes and to communicate charging status. The device uses vibrations coupled with positive expiratory pressure to improve airway functionality and mucous movement. Positive expiratory pressure (PEP) therapy involves breathing with a slightly active expiration against an expiratory resistance. The way the device achieves PEP is to slightly narrow the nostril openings via a pinching effect from the elasticity of the spring inside the device. This increases the pressure when the user exhales.

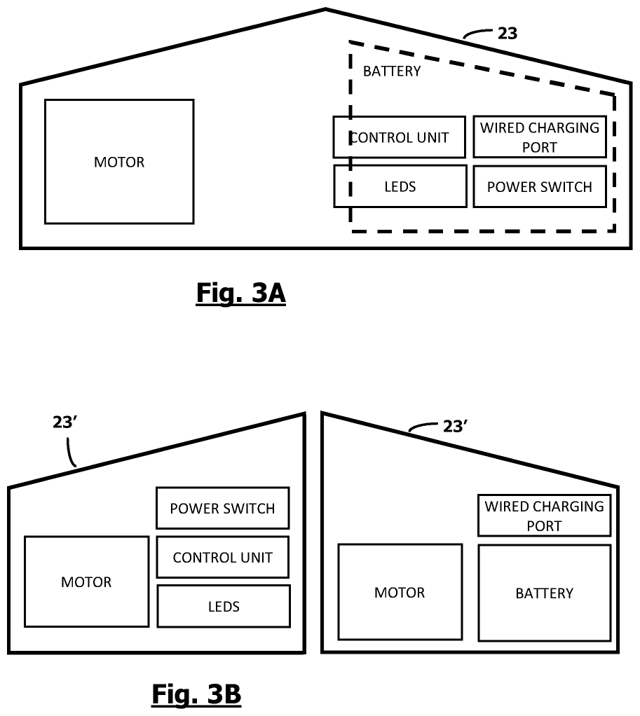

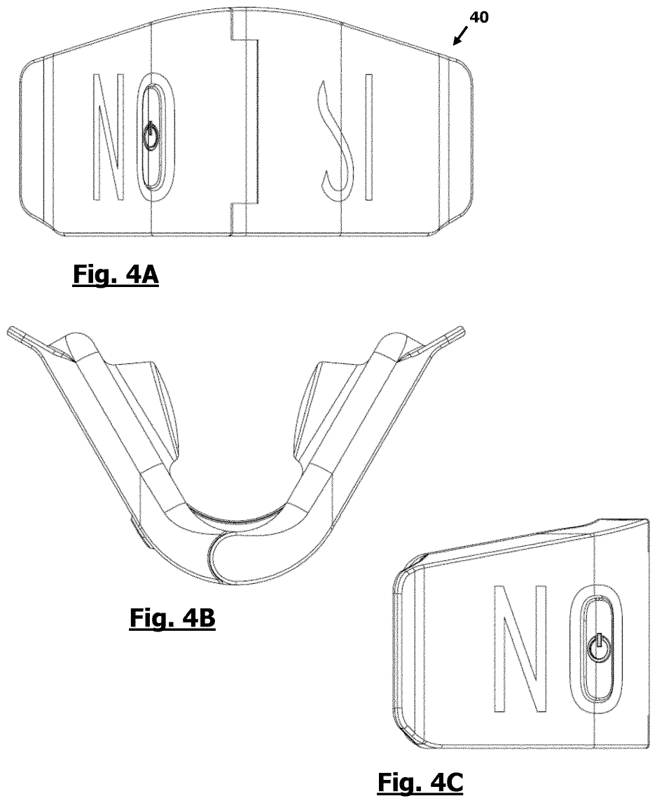

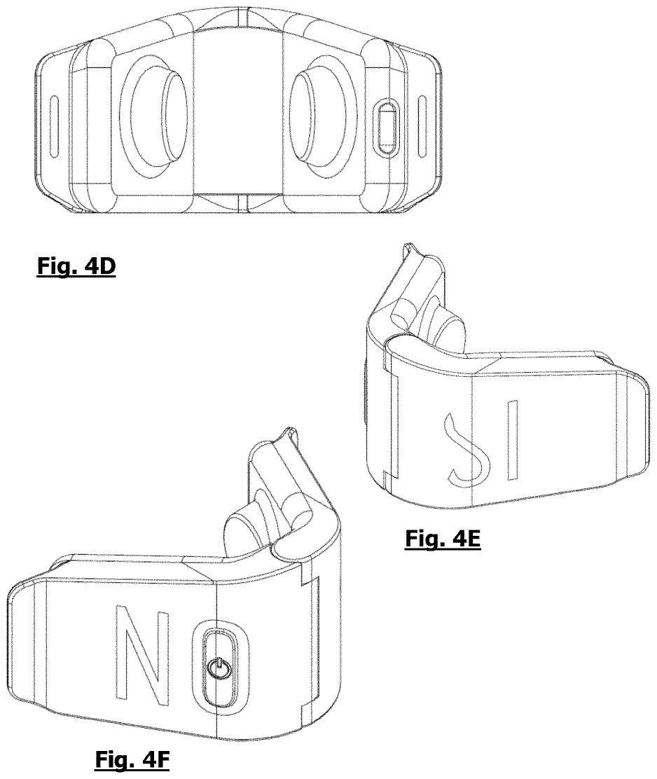

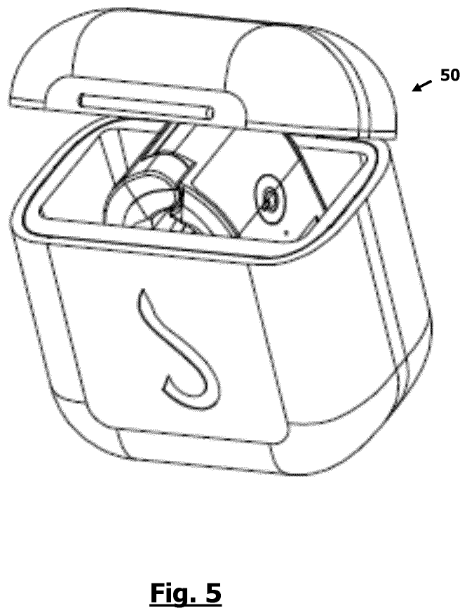

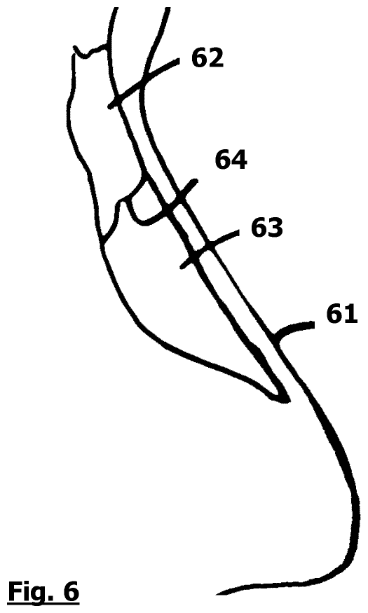

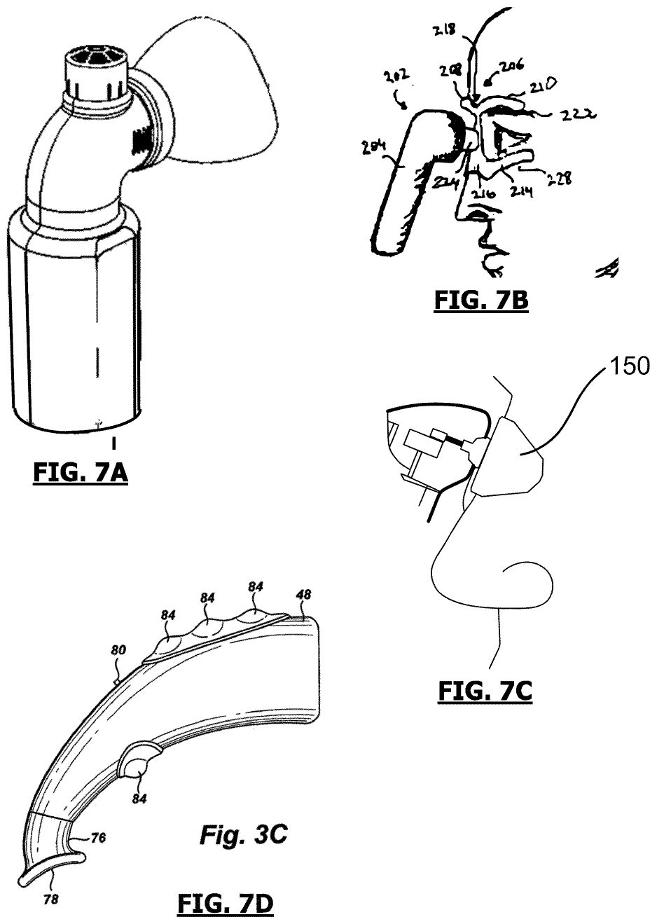

Specifically, referring to FIG. 2, the vibration mechanism 20 comprises a single motor 21 (though multiple motors or an alternative such as piezoelectric element(s) could be used), a rechargeable battery 22 and a corresponding wired charge port 16 (a wireless alternative could be used), a control unit 24, a power switch 17 and an LED signal light 26, all connected via a flexible circuit board 23. The flexible circuity board has the same tapered shape as both hinged members and extends between both hinged members such that the components of the vibration mechanism 20 are asymmetrically distributed between both hinged members 11, 11′. The layout of the flexible circuit board is shown in FIG. 3A where the components are distributed either side of the hinge and where the single motor 21 is located on one side and the remaining components located on the other. The battery is also located on the other, not mounted on the circuit board but rather mounted above (or below) the circuit board. The flexible circuit board and any conductive tracks deposited thereon flex with the hinged members. The reason for doing so is to ensure that one hinged member weigh no more than 150% and ideally either 130%, 120% or 110% of the other. That is, so that they are roughly equal in weight for a user comfort. For example, as evident from FIG. 3A, the motor is housed by one hinged member and the battery housed by the other hinged member.

FIG. 3B illustrates an alternative physical layout of the components of a vibrating nasal device in which rigid circuit board elements 23, 23′ are shown, requiring electrical connection between the two such as by a ribbon cable configured to flex with the hinge or other means. In this alternative, two motors are provided, one either side of the hinge and the battery is mounted on one of the circuit board elements.

An alternative characterisation of the device based on the physical layout of the components would be one comprising an elongate body housing a complete vibration mechanism adapted to provide a vibration of sufficient magnitude to provide congestive relief for a user, wherein the elongate body having a curved profile to receive the bridge of a user's nose, and wherein components of the vibration mechanism are housed by the elongate body both sides of the curved profile and/or comprised a flexible circuit board. The device is ideally made of recycled plastic, coating in silicon for comfort and simple maintenance since waterproof silicone can be readily cleaned after use. Ideally, the wired charging port is waterproof, USB-C port.

Referring to FIGS. 4A to 4F, a further vibrating nasal device 40 is shown of the same design of that illustrated in FIGS. 1A to 1F and described above, with the exception that the left 11 and right 11′ hinged members are truncated and do not have an inflected profile complementing the transition from the side of a nose to an adjacent infra-orbital region of a user's face (e.g. as compared to 13, 13′ in FIG. 1C). Thus, there is no provision for with contact areas for contacting the infra-orbital region of a user's face.

FIG. 5 illustrates a charging case 50 for a vibrating nasal device according to the present invention and, specifically, that shown in FIGS. 4A to 4F. The charging case is shaped internally (not shown) so as to guide the device 10, 40 when receiving it so as to make electrical contact between the charging box and the device 10, 40. The charging device itself may have an internal battery which can be charged in a wired or wirelessly fashion so that the charging of the nasal device may be effected from the case.

To function optimally, the position of the device is be located on the nose, with the raised contact pads 14, 14′ for contacting and transmitting vibration to respective interfaces between the nasal bone and upper lateral cartilage meets as shown in FIG. 6. The motor is particularly effective at 128 Hz though would work at 50 Hz-250 Hz. The device is optimally used for 2 minutes, twice a day. The user must exhale and inhale deeply while the device is on Other modifications are contemplated such as Bluetooth/smart app connectivity, a usage timer, integration of scented strips (menthol, lavender, lemongrass etc.), automatic start/stop when the user takes the device on/off or when the hinge is open/closed, auto-detect when the device is worn, providing audible feedback when the device starts and stops etc. Sensor(s) may be provided on the device for contacting the user and providing data such as heart rate, temperature, blood oxygen saturation levels and nasal airflow characteristics; such data being recorded and/or exportable such as to an external phone for subsequent analysis. Further modifications will suggest themselves to persons skilled in the art.

1. A vibrating nasal device configured to provide congestive relief, the device comprising two hinged members collectively housing a complete vibration mechanism configured to provide a vibration of sufficient magnitude to provide congestive relief.

2. A device according to claim 1, wherein the vibration mechanism comprises a motor(s) or piezoelectric element(s), a battery and a control element.

3. A device according to claim 2, wherein the vibration mechanism further comprises at least one of a rechargeable battery a wireless or wired charge port a control unit a control actuator(s), or a control light(s).

4. (canceled)

5. A device according to claim 1, wherein the vibration mechanism comprises a flexible circuit board extending between both hinged members.

6. A device according to claim 1, wherein part of the vibration mechanism is housed by one hinged member and the rest of the vibration mechanism is housed by the other hinged member.

7. A device according to claim 6, wherein there is a single motor housed by one hinged member and a single battery housed by the other hinged member.

8. A device according to claim 6, wherein the parts of the vibration mechanism housed by one hinged member weigh no more than 150% of the remaining parts of the vibration mechanism housed by the other hinged member.

9. A device according to claim 6, wherein the parts of the vibration mechanism housed by one hinged member weigh no more than 120% of the remaining parts of the vibration mechanism housed by the other hinged member.

10. A device according to claim 1, wherein, the hinged members collectively form a curved profile at one end adjacent the hinge to receive the bridge of a nose.

11. A device according to claim 10, wherein both hinged members have a curved profile at one end adjacent the hinge.

12. A device according to claim 1, wherein both hinged members are tapered from a wider section adjacent the hinge to a narrow section away from the hinge.

13. A device according to claim 1, wherein both hinged members are elongate with an inflection to complement the transition from the side of a nose to an adjacent infra-orbital region of a user's face.

14. A device according to claim 1, wherein both hinged members have, at the end opposite that adjacent the hinge, a contact area for contacting the infra-orbital region of a user's face.

15. A device according to claim 1, wherein at least one hinged member has, at the end opposite that adjacent the hinge, a detent which enables a user to grip behind that hinged member to unclip the device from the user's nose when the device is worn.

16. A device according to claim 1, wherein at least one hinged member has a control actuator on a surface facing away from a user's nose so that the control actuator is accessible when the device is worn.

17. A device according to claim 1, wherein the end of at least one hinged member has a wired charging port so that the device can be charged when the device is worn.

18. A device according to claim 1, wherein both hinged members have a raised contact area for contacting and transmitting vibration to a respective side of a user's nose.

19. A device according claim 18, wherein both hinged members are configured with a size and shape to apply vibration to an interface between a respective side of a user's nasal bone and connected upper lateral cartilage

20. A vibrating nasal device according to claim 1, comprising an elongate body housing the complete vibration mechanism (20) and having a curved profile to receive the bridge of a user's nose and respective inflected profiles to complement the transition from the sides of a user's nose to respective adjacent infra-orbital region of a user's face.

21. A device according to claim 20, wherein the elongate body is tapered from a wider section adjacent the curved profile to respective narrower sections adjacent the inflected profiles.

22.-29. (canceled)
